(19) United States
(12) Patent Application Publication
(10) Pub. No.: US 2004/0128825 A1
(43) Pub. Date: Jul. 8, 2004

(54) Laminated membrane electrode seal assembly

(76) Inventor: Mark A. Belchuk, Windsor (CA)

Correspondence Address: FREUDENBERG-NOK GENERAL PARTNERSHIP, INTELLECTUAL PROPERTY DEPT., 47690 EAST ANCHOR COURT, PLYMOUTH, MI, 48170-2455, US

(21) Appl. No.: 10/738,653

(22) Filed: Dec. 17, 2003

Related U.S. Application Data
(60) Provisional application No. 60/437,553, filed on Dec. 31, 2002.

(51) Int. Cl. H01M 2/00; H01M 4/00

(52) U.S. Cl. 29/623.1; 429/27; 429/34

(57) ABSTRACT

An integrated gasket and membrane electrode assembly (MEA) for a fuel cell includes a first gasket having a first perimeter surface and an MEA having a first surface. A portion of the first surface is bonded to the first perimeter surface. Alternatively, the integrated gasket and MEA includes a first gasket having a first perimeter surface and a second gasket having a second perimeter surface. Portions of the first and second perimeter surfaces are bonded together. An MEA is disposed between the first gasket and the second gasket. Bonding is achieved by heat staking, friction welding or vibration welding.

### CROSS-REFERENCE TO RELATED APPLICATIONS

This application claims the benefit of U.S. Provisional Application No. 60/437,553, filed on Dec. 31, 2002.

### FIELD OF THE INVENTION

This invention relates in general to static seals and more particularly to a gasket employed for sealing between components in a fuel cell.

### BACKGROUND OF THE INVENTION

A fuel cell is an electrochemical energy converter that includes two electrodes placed on opposite surfaces of an electrolyte. In one form, an ion-conducting polymer electrolyte membrane is disposed between two electrode layers (also sometimes called gas diffusion layers), with layers of a catalyst material between the membrane and the electrode layers, to form a membrane electrode assembly (MEA). The MEA is used to promote a desired electrochemical reaction from two reactants. One reactant, oxygen or air, passes over one electrode while hydrogen, the other reactant passes over the other electrode. The oxygen and hydrogen combine to produce water, and in the process generate electricity and heat.

An individual cell within a fuel cell assembly includes a MEA placed between a pair of separator plates (also sometimes called flow field plates). The separator plates are typically fluid impermeable and electrically conductive. Fluid flow passages or channels are formed adjacent to each plate surface at an electrode layer to facilitate access of the reactants to the electrodes and the removal of the products of the chemical reaction.

In such fuel cells, resilient gaskets are seals or typically provided between the faces of the MEA and the perimeter of each separator plate to prevent leakage of the fluid reactant and product streams. Also, an adhesive may be employed between the gaskets in order to seal around the perimeter of the MEA. Since the fuel cell operates with oxygen and hydrogen, it is important to provide a seal that not only seals well against hydrogen, oxygen and water, but that will seal well as the temperature changes due to the heat that is given off during fuel cell operation. To assure a good seal, the seals need to be formed accurately as well as aligned properly with the other components. In particular, the gaskets can be difficult to assemble into a cell because they are flexible and may have a tendency to bend or twist. This can make proper alignment of the cell components time consuming and prone to misassembly. An adhesive (and in particular, a pressure sensitive adhesive) can be employed to aid in the assembly and sealing of components, but it is not always desirable to use an adhesive in a cell assembly. The assembly cycle time may be more than is desirable because one must wait for the adhesive to cure. Moreover, the gasket may need to be thicker than is otherwise necessary in the area of the pressure sensitive adhesive in order to obtain the proper adhesion of the adhesive during assembly.

Thus, it is desirable to have a gasket of an individual cell of a fuel cell that is relatively easy to align and secure to the other components during an assembly operation, while assuring the proper sealing for the finished assembly.

### SUMMARY OF THE INVENTION

In its embodiments, the present invention contemplates an apparatus for use in an individual cell comprising a first gasket including a first surface adjacent to a first perimeter; a second gasket including a second surface adjacent to a second perimeter; and a membrane located between the first gasket and the second gasket such that the membrane is heat staked to the first surface and the second surface.

The present invention further contemplates an apparatus for use in an individual cell comprising: a first gasket including a first surface adjacent to a first perimeter; a second gasket including a second surface adjacent to a second perimeter; a membrane located between the first gasket and the second gasket; and wherein the first surface and the second surface are vibration welded together.

The present invention also contemplates a method of assembling a first gasket and a second gasket to a membrane, the method comprising the steps of: locating the membrane between the first gasket and the second gasket; and vibration welding a first surface of the first gasket and a second surface of the second gasket to the membrane about a perimeter of the membrane.

The present invention additionally contemplates a method of assembling a first gasket and a second gasket to a membrane, the method of comprising the steps of: locating the membranes between the first gasket and the second gasket; and heat staking a first surface of the first gasket to a second surface of the second gasket around a perimeter of the membrane.

An advantage of the present invention is that gaskets that are secured directly together will allow for proper sealing around an MEA in a cell, without requiring the use of an adhesive.

Another advantage of the present invention is that the gasket material of the laminated gaskets can be generally thinner at the periphery where the gaskets are secured together. Moreover, heat staking or vibration welding the gaskets together will allow for a greater thickness tolerance in the parts than when employing a layer of pressure sensitive adhesive.

An additional advantage of the present invention is that the cycle time for the cell is reduced by eliminating the need for an adhesive cure time.

Also, an advantage of the present invention is that the elimination of adhesive eliminates the possibility that the adhesive might contaminate the catalyst coated membranes during assembly of the components.

### BRIEF DESCRIPTION OF THE DRAWINGS

The present invention will become more fully understood from the detailed description and the accompanying drawings, wherein:

FIG. 1 is a schematic, exploded, perspective view of an individual cell of a fuel cell assembly prior to sealing the gaskets together;

FIG. 2 is a partial, sectional view of a gasket and MEA assembly; and

FIG. 3 is a sectional view similar to FIG. 2, but illustrating an alternate embodiment of the present invention.

### DETAILED DESCRIPTION OF THE PREFERRED EMBODIMENTS

The following description of the preferred embodiments is merely exemplary in nature and is in no way intended to limit the invention, its application, or uses.

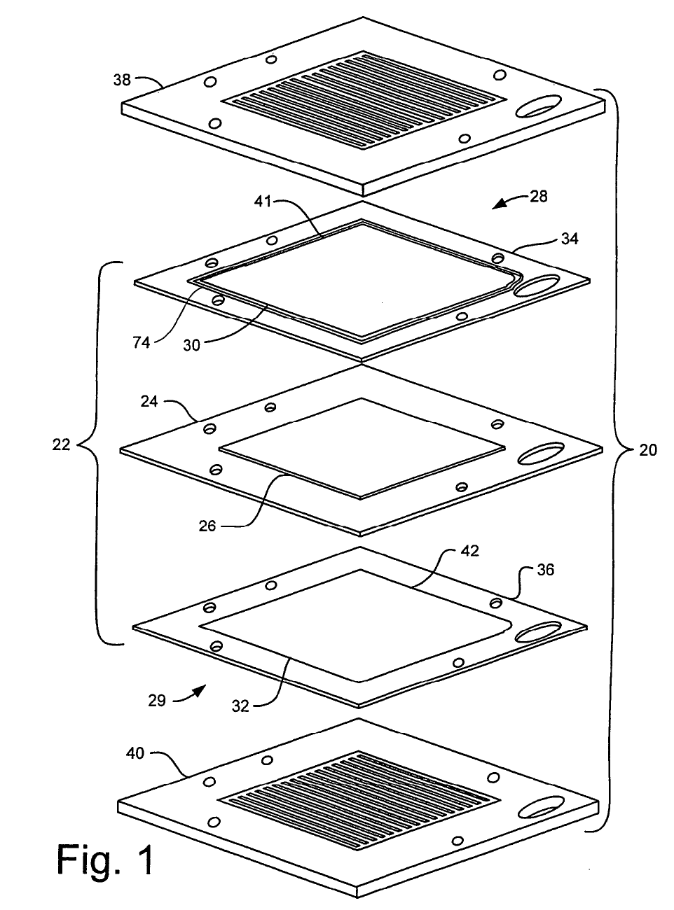

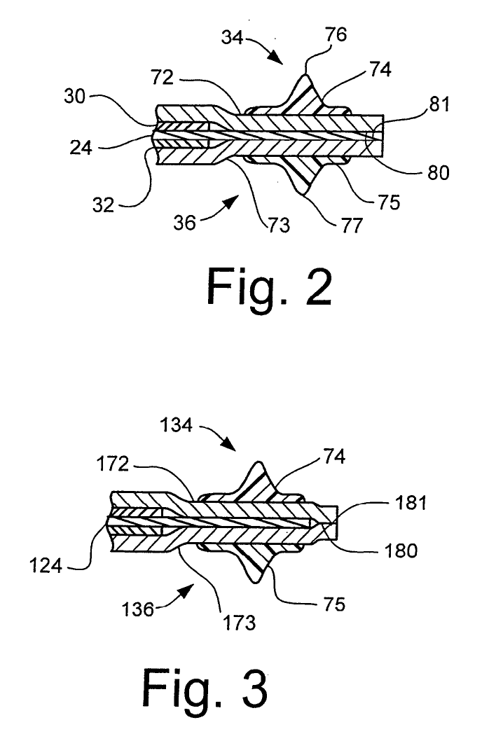

FIGS. 1-2 illustrate an individual cell 20 for use in a fuel cell assembly. The individual cell 20 preferably includes a gasket unitized membrane electrode assembly (MEA) 22, (although the gasket may be separate rather than unitized, if so desired). The MEA 22 is made up of a membrane 24, with a layer of catalyst material 26, on both sides of the membrane 24. The MEA also includes a first gas diffusion layer (GDL) 30 and second GDL 32 on either side of the layers of catalyst material 26, and a first gasket 34 and a second gasket 36, secured around the perimeters 41, 42 of the first GDL 30 and the second GDL 32, respectively. Preferably, the gaskets 34, 36 are secured to the GDLs 30, 32 by adhesive, although other means of securing may be used if so desired, such as molding each gasket to its GDL. Each GDL 30, 32 and its corresponding gasket 34, 36 forms a unitized seal-diffusion assembly 28, 29 respectively. A first separator plate 38 mounts against the first gasket 34 and the first GDL 30, and a second separator plate 40 mounts against the second gasket 36 and the second GDL 32, in order to form the individual cell 20. Since the relative thicknesses of the various components are very thin, they are only depicted schematically in the figures in order to aid in describing the invention. The actual thicknesses of the components may vary according to the particular application of the fuel cell and are known to those skilled in the art. Also, the components of the cell 20 are generally symmetric about the membrane 24.

The membrane 24 is preferably an ion-conducting, polymer electrolyte membrane, as generally employed in this type of fuel cell application. The catalyst material 26 is preferably platinum or other suitable catalyst material for a typical polymer electrode membrane type of fuel cell application. The first and second GDLs 30, 32 are preferably a carbonized fiber, or may be another suitable gas permeable material for use as an electrode in a fuel cell. The MEA 22 can include a catalyzed membrane with GDLs assembled thereto, or a membrane assembled between two catalyzed GDL's, each of which is known to those skilled in the art.

The gaskets 34, 36 are each preferably a laminated gasket with a thin, flexible carrier 72, 73 upon which an elastomeric seal 74, 75, respectfully, is secured—with each elastomeric seal 74, 75 preferably including a sealing bead 76, 77 projecting therefrom. Each carrier 72, 73 preferably has a thickness of less than 1.0 millimeters and is preferably made from a polymer substrate, such as, for example polyimide or polyester. Each elastomeric seal 74, 75 is preferably molded to its carrier 72, 73 although other means of securing the two may also be employed. The sealing beads 76, 77 are designed to be compressed against the surface of its corresponding separator plate 38, 40 and held with sufficient sealing force to prevent migration of fluid past the seal along the surface of the particular separator plate 38, 40. While the sealing beads 76, 77 are shown in the shape of a triangle, different shapes may also be employed, if so desired.

The membranes 24 generally extends to the perimeter of the unitized seal-diffusion assemblies 28, 29. During assembly of the unitized MEA 22, the unitized seal-diffusion assemblies 28, 29 are aligned with and brought together around the membrane 24. These components are then held together while a heat staking process is employed to secure and seal the first surfaces 80, 81 of the gaskets 34, 36 respectively, to the membrane 24. Alternatively, a vibration welding process is employed to secure and seal the first surfaces 80, 81 to the membrane 24. Thus, the unitized MEA 22 is held together and sealed about its perimeter without applying an adhesive thereabout. After this assembly step, then the separator plates 38, 40 are assembled in order to form a cell 20.

FIG. 3 illustrates another embodiment of the present invention. In this embodiment, similar elements to the first embodiment will be similarly designated, but with a 100 series number. In this embodiment, the membrane 124 does not extend all of the way to the perimeter of the gaskets 134, 136. Instead, it only extends out about as far as the elastomeric seals 74, 75. The carriers 172, 173, then, are brought together along their first surfaces 180, 181 around the perimeter of the unitized MEA. After being aligned, then, the carriers 172, 173 are heat staked or vibration welded together in order to seal and secure about the perimeter of the unitized MEA.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An integrated gasket and membrane electrode assembly (MEA) for a fuel cell, comprising:
a first gasket having a first perimeter surface; and
a membrane electrode assembly (MEA) having a first surface, wherein a portion of said first surface is bonded to said first perimeter surface.

2. The integrated gasket and MEA of claim 1 further comprising a gas diffusion layer disposed between said first gasket and said MEA.

3. The integrated gasket and MEA of claim 1 further comprising a seal secured to said first gasket.

4. The integrated gasket and MEA of claim 1 further comprising a second gasket having a second perimeter surface, wherein said second surface of said MEA is bonded to said second perimeter surface.

5. The integrated gasket and MEA of claim 4 further comprising a gas diffusion layer disposed between said gasket and said MEA.

6. The integrated gasket and MEA of claim 4 further comprising a seal secured to said second gasket.

7. The integrated gasket and MEA of claim 1 wherein said portion of said first surface is heat staked to said first perimeter surface.

8. The integrated gasket and MEA of claim 1 wherein said portion of said first surface is friction welded to said first perimeter surface.

9. The integrated gasket and MEA of claim 1 wherein said portion of said first surface is vibration welded to said first perimeter surface.

10. An integrated gasket and membrane electrode assembly (MEA) for a fuel cell, comprising:
a first gasket having a first perimeter surface;
a second gasket having a second perimeter surface, wherein portions of said first and second perimeter surfaces are bonded together; and
a membrane electrode assembly (MEA) disposed between said first gasket and said second gasket.

11. The integrated gasket and MEA of claim 10 further comprising a gas diffusion layer disposed between said first gasket and said MEA.

12. The integrated gasket and MEA of claim 10 further comprising a gas diffusion layer disposed between said second gasket and said MEA.

13. The integrated gasket and MEA of claim 10 further comprising a seal secured to said first gasket.

14. The integrated gasket and MEA of claim 10 further comprising a seal secured to said second gasket.

15. The integrated gasket and MEA of claim 10 wherein said portions of said first and second perimeter surfaces are heat staked together.

16. The integrated gasket and MEA of claim 10 wherein said portions of said first and second perimeter surfaces are friction welded together.

17. The integrated gasket and MEA of claim 10 wherein said portions of said first and second perimeter surfaces are vibration welded together.

18. A method of assembling a fuel cell, comprising:
placing a membrane electrode assembly (MEA) between first and second gaskets; and
bonding a portion of a first surface of said MEA to a first perimeter surface of said first gasket.

19. The method of claim 18 wherein said step of bonding comprises heat staking said portion of said first surface of said MEA to said first perimeter surface of said first gasket.

20. The method of claim 18 wherein said step of bonding comprises friction welding said portion of said first surface of said MEA to said first perimeter surface of said first gasket.

21. The method of claim 18 wherein said step of bonding comprises vibration welding said portion of said first surface of said MEA to said first perimeter surface of said first gasket.

22. The method of claim 18 further comprising bonding a portion of a second surface of said MEA to a second perimeter surface of said second gasket.

23. The method of claim 22 wherein said step of bonding comprises heat staking said portion of said first surface of said MEA to said first perimeter surface of said first gasket.

24. The method of claim 22 wherein said step of bonding comprises friction welding said portion of said first surface of said MEA to said first perimeter surface of said first gasket.

25. The method of claim 22 wherein said step of bonding comprises vibration welding said portion of said first surface of said MEA to said first perimeter surface of said first gasket.

26. The method of claim 18 further comprising disposing a gas diffusion layer between said MEA and said first gasket.

27. The method of claim 18 further comprising disposing a gas diffusion layer between said MEA and said second gasket.

29. A method of assembling a fuel cell, comprising:
placing a membrane electrode assembly (MEA) between first and second gaskets; and
bonding a first perimeter surface of said first gasket to a second perimeter surface of said second gasket.

30. The method of claim 29 wherein said step of bonding comprises heat staking said first perimeter surface to said second perimeter surface.

31. The method of claim 29 wherein said step of bonding comprises friction welding said first perimeter surface to said second perimeter surface.

32. The method of claim 29 wherein said step of bonding comprises vibration welding said first perimeter surface to said second perimeter surface.

33. The method of claim 29 further comprising disposing a gas diffusion layer between said MEA and said first gasket.

34. The method of claim 29 further comprising disposing a gas diffusion layer between said MEA and said second gasket.
